(19) United States
(12) Patent Application Publication
(10) Pub. No.: US 2013/0136911 A1
(43) Pub. Date: May 30, 2013

(54) FLAME-RETARDANT POLYMER FIBRES AND USE THEREOF AND TEXTILE FABRIC COMPRISING THESE POLYMER FIBRES

(71) Applicant: EMS-Patent AG, Domat/Ems (CH)

(72) Inventors: Klaus Bender, Bonaduz (CH); Gunther Schach, Chur (CH)

(73) Assignee: EMS-PATENT AG, Domat/Ems (CH)

(21) Appl. No.: 13/674,395

(22) Filed: Nov. 12, 2012

(30) Foreign Application Priority Data
Nov. 24, 2011 (EP) 11 190 598.0

(51) Int. Cl. C09K 21/14; D04H 13/00

(52) U.S. Cl. CPC C09K 21/14; D04H 13/00
USPC 428/221; 525/411; 524/538

(57) ABSTRACT

The flame-retardant polymer fibre according to the invention comprises a PA66/PA6 polymer blend having the following composition: 60 to 90% by weight of polyamide 66, 6 to 25% by weight of polyamide 6, 4 to 10% by weight of at least one halogen-free flame retardant made of a polycondensate of a) at least one phosphorus-containing monomer selected from adducts of a1) 9,10-dihydro-9-oxa-10-phosphaphenanthrene-10-oxide (DOPO) and/or nuclear-substitution DOPO derivatives in a2) unsaturated compounds from the group of mono- and multivalent carboxylic acids and the anhydrides thereof and b) at least one ester-forming monomer selected from the group of mono- or multivalent alcohols and mixtures thereof. In addition to the flammability resistance, the polymer fibre according to the invention has very good textile-mechanical properties, and is resistant to washing-out of the flame retardant.

### CROSS-REFERENCE TO A RELATED APPLICATION

This patent application claims the benefit of European Patent Application No. EP 11 190 598.0, filed Nov. 24, 2011, the disclosure of which is incorporated herein by reference.

### FIELD OF THE INVENTION

The present invention relates to flame-retardant polymer fibres (staple fibres and filaments) made of a polymer blend of polyamide 6 and polyamide 66 and also of at least one halogen-free flame retardant.

### BACKGROUND OF THE INVENTION

Flame-retardant polymer compositions, e.g. based on polyamides, are used for the production of moulded articles in a large number of application fields because of their excellent property profile. It is thereby essential in particular for components in the electrical and in the electronics industry that the polymer composition has excellent flame-retardant properties in order thus to ensure adequate fire protection. In addition to these excellent fire protection properties, it is however thereby important that also the further physical properties, such as e.g. tensile modulus, tear strength and breaking elongation, fulfil the prescribed requirements for the respective application cases.

A whole series of non-reactive flame retardants for the production of flame-retardant polyamides in technical application have already been known for a long time. However these are generally based on halogen- or antimony-containing substances which are undesirable because of their ecotoxicological or genotoxicological potential. For this reason, halogen-free flame retardants are used for preference in the meantime.

Halogen-free flame retardants which are based on phosphorus-containing monomers and are used for thermoplastic polymer compositions are known from WO 2009/109347 A1. The flame retardant used here has an average molecular weight of over 20,000 and is preferably used for the production of polyamide fibres and polyester fibres in a high-speed spinning method.

WO 2011/000457 A1 describes flame-retardant polymer compositions made of a polyamide or a polybutylene terephthalate which comprise a selected phosphorus compound as flame retardant. Moulded parts formed herefrom for electrical or electronic appliances are likewise described.

Furthermore, WO 2010/019746 A2 describes flame-retardant polymer composite systems. Organoclays in combination with inorganic flame retardants, such as e.g. potassium bromide, are used here as flame retardants. There are mentioned here as polymer systems, polyamides, polyesters, polylactic acid (PLA), polypropylene and acrylic polymers. The polymer composite systems are used in the form of flame-retardant fibres or flame-retardant carpets.

However, it is common to all flame-retardant systems described in the state of the art that often significant losses with respect to the further physical properties, e.g. tenacity, elongation or abrasion resistance, must be accepted here. This leads to a significant reduction in the extent of use of such polymers since the just-mentioned properties are indispensable in the application fields.

### BRIEF SUMMARY OF THE INVENTION

It was therefore the object of the present invention to provide flame-retardant polymer fibres which, in addition to the flame-retardant properties, have improved properties also with respect to tenacity, elongation and abrasion resistance.

This object is achieved by the features of the flame-retardant polymer fibre and the textile fabric described herein, and the advantageous developments thereof. Uses according to the invention are also described.

### DETAILED DESCRIPTION OF THE INVENTION

According to the invention, a flame-retardant polymer fibre made of a polymer blend of polyamide 6 and polyamide 66 having a composition comprising the following components is provided:
I) 60 to 90% by weight of polyamide 66,
II) 6 to 28% by weight of polyamide 6,
III) 4 to 12% by weight of at least one halogen-free flame retardant made of a polycondensate of
   a) at least one phosphorus-containing monomer which is selected from adducts of
      a1) 9,10-dihydro-9-oxa-10-phosphaphenanthrene-10-oxide (DOPO) and/or nuclear-substitution DOPO derivatives in
      a2) unsaturated compounds from the group of mono- and multivalent carboxylic acids and the anhydrides thereof and
   b) at least one ester-forming monomer selected from the group of mono- or multivalent alcohols and mixtures thereof.

In a preferred embodiment, the polymer fibre according to the invention comprises the following composition:
I) 75 to 86% by weight, in particular 80 to 85% by weight, of polyamide 66,
II) 7 to 15% by weight, in particular 7.5 to 11% by weight, of polyamide 6,
III) 7 to 10% by weight, in particular 7.5 to 9% by weight, of at least one halogen-free flame retardant of the polycondensate.

Preferred unsaturated mono- or dicarboxylic acids for reaction with DOPO are sorbic acid, acrylic acid, crotonic acid, maleic acid, fumaric acid, endomethylene tetrahydrophthalic acid, mesaconic acid, tetrahydrophthalic acid and itaconic acid and also the anhydrides thereof. Itaconic acid, maleic acid and the anhydrides thereof are particularly preferred. Itaconic acid is most preferred.

There are used as ester-forming monomers for forming the flame retardant according to the invention, preferably saturated mono- and multivalent alcohols. Particularly preferred ester-forming monomers are aliphatic bivalent alcohols, such as e.g. monoethylene glycol, diethylene glycol, propylene glycol, 1,3-propanediol, 1,3-butanediol, neopentyl glycol, hexanediol and 1,10-decanediol. Preferred multivalent alcohols are tris-2-hydroxyethylisocyanurate (THEIC), glycerine, trimethylolethane, trimethylolpropane and pentaerythrite and also sugar alcohols such as mannite A particularly preferred alcohol is diethylene glycol.

This involves preferably a polyester with 5 to 9% by weight of phosphorus and particularly preferred a polyester with 7.5 to 8.5% by weight of phosphorus.

It was found surprisingly that a polymer blend of polyamide 6 and polyamide 66, with polyamide 66 as main component, together with the halogen-free flame retardant according to the invention passes the flame test according to FAR 25.853 (appendix F, part 1, 12 seconds, obtainable from the Federal Aviation Association) and furthermore has even better textile-mechanical properties than a pure polyamide 66 fibre, according to the composition of the blend. The product of the tenacity in cN/dtex, the square root of the elongation in percent and the common logarithm (log) of the number of cycles until fibre breakage in the wire abrasion test, by means of which the abrasion is quantified, serves as indicator for the textile-mechanical properties. This is surprising for the reason that generally PA6 has better textile-mechanical properties than PA66, the addition of a halogen-free flame retardant still drastically impairing the textile-mechanical properties. Because of the very disadvantageous flame properties of PA6, the use of PA66 as main component is absolutely necessary.

In addition to the very good textile-mechanical properties, the fibres according to the invention have, as further positive property, resistance to washing-out of the flame retardant.

In a preferred embodiment, the polymer fibre according to the invention comprises at least one additive. Relative to the total quantity of PA6, PA66 and the flame retardant according to the invention, these additives are added in 0.001 to 5% by weight, preferably in 0.01 to 4% by weight, particularly preferred in 0.1 to 2% by weight, particularly preferred in 0.1 to 1% by weight and most preferred in 0.1 to 0.5% by weight.

In a further preferred embodiment, the polymer fibre according to the invention has the following composition:
IV) 75 to 85.99% by weight, in particular 80 to 84.9% by weight, of polyamide 66,
V) 7 to 11% by weight, in particular 7.5 to 9% by weight, of polyamide 6,
VI) 7 to 10% by weight, in particular 7.5 to 9% by weight, of at least one halogen-free flame retardant of the polycondensate,
VII) 0.01 to 4% by weight, in particular 0.1 to 2% by weight, of the at least one additive.

In the sense of the invention, the at least one additive is added only in quantities which enable textile-mechanical properties of greater than 100 cN/dtex for the polymer fibre to be obtained.

Preferably, the at least one additive is added in quantities which enable the polymer fibres to fulfil the flame test requirements according to FAR 25.853.

It is further preferred that the at least one additive is added in a quantity such that the polymer fibre has a quality number in the range of 28 to 50.

The at least one additive is preferably a further flame retardant and thereby selected for particular preference from the group of nitrogen-containing compounds, nitrogen- and phosphorus-containing compounds and mixtures hereof.

The at least one additive can be selected furthermore preferably from inorganic stabilisers, organic stabilisers, colourants and marking materials, inorganic pigments, organic pigments, matting agents, IR absorbers, heat stabilisers, antistatic agents, antiblocking agents, nucleation agents, crystallisation accelerators, crystallisation inhibitors, chain-lengthening additives, conductivity additives, carbon black, graphite, carbon nanotubes, optical brighteners, photochromic additives, crosslinking agents, intumescence agents, foreign polymers and/or mixtures thereof.

As additive, preferably matting agents are added. A particularly preferred matting agent is thereby titanium dioxide.

No layer silicates are contained in a preferred embodiment.

The polymer fibre preferably has textile-mechanical properties (determined from the product of the tenacity in cN/dtex, the square root of the elongation in % and the common logarithm of the number of cycles until fibre breakage in the wire abrasion test) of greater than 100 cN/dtex, preferably of greater than 110 cN/dtex, particularly preferred of greater than 120 cN/dtex, even more preferred of greater than 140 cN/dtex and most preferred of greater than 160 cN/dtex.

The polymer fibre preferably has an abrasion resistance in the wire abrasion test of 10,000 to 50,000 cycles, particularly preferred of 11,000 to 50,000 cycles and even more preferred of 12,500 to 50,000 cycles until fibre breakage.

The polymer fibre preferably has a tenacity in [cN/dtex] of 3.5 to 6.0, particularly preferred 4.0 to 5.8 and even more preferred of 4.2 to 5.5.

The polymer fibre preferably has an elongation of 30 to 120%, particularly preferred of 40 to 110% and particularly preferred of 60 to 105%.

The polymer fibre preferably has textile-mechanical properties of greater than 100 cN/dtex, the abrasion resistance in the wire abrasion test being greater than 10,000.

The polymer fibre preferably has textile-mechanical properties of greater than 100 cN/dtex, the tenacity being greater than 4.0 cN/dtex.

The polymer fibre preferably has textile-mechanical properties of greater than 100 cN/dtex, the elongation being greater than 60%.

The polymer fibre preferably has a quality number of 28 to 50, preferably of 30 to 45 and particularly preferred of 34 to 45.

Preferably, the polymer fibre has increased extraction resistance which is measured by means of extraction from 5 g of polymer fibre in 150 ml deionised water over three hours at 98° C., the phosphorus content differing before and after the extraction by less than 2.5%, preferably by less than 1.5%.

According to the invention, a textile fabric comprising flame-retardant polymer fibres, as were described above, is likewise provided.

The flame-retardant polymer fibres are used for the production of textile fabrics for use in mobile means of transport, in particular in aeroplanes, trains and motor vehicles. In these mobile means of transport, they are used preferably as seat covers, carpets or curtains. Furthermore, they are used in curtains, blinds and seat covers in public buildings, such as cinemas, theatres and restaurants, and also for clothing- and protective materials, for textile floor coverings, seat upholstery and furniture cover materials.

The subject according to the invention is intended to be explained in more detail with reference to the following examples without wishing to restrict said subject by the specific embodiments shown here.

### EXAMPLES

In the following, polymer fibres, as are known from the state of the art, and also polymer fibres according to the invention are described in more detail with respect to the production thereof and the properties thereof.

The following starting materials were used for production:
PA66 (Radici Radipol A45, BASF Ultramid A 3401)
PA6 (EMS Grilon A26)
Flame retardant: Ukanol FR80 (Schill+Seilacher)
Flame retardant: Cloisite 20A (Rockwood Additives Ltd.)
Flame retardant: FR-Masterbatch CF-50B937 (IQAP Masterbatch Group S.L.)

Drying or conditioning was effected for the following components:

PA66 and PA6 were conditioned to the moisture suitable for spinning (PA66 Radici Radipol A45: H₂O: 0.07% by weight, RV=1.85, PA6 EMS Grilon A26: H₂O: 0.04% by weight, RV=1.77, PA66 BASF Ultramid A 3401: H₂O: 0.04% by weight, RV=2.06, RV measured in all cases according to DIN51562-1 (0.5% PA in m-cresol; sample preparation: agitated for 90 minutes at 95° C., then cooled to 20° C. and measured at this temperature)).

Ukanol FR 80 was dried in the rotating vacuum dryer to 0.2% moisture for 24 h at 55° C. PT and at 1 mbar vacuum [H₂O: 0.271% by weight, RV=1.202, measured according to DIN51562-1 (1% Ukanol FR80 in m-cresol; sample preparation: agitated for 90 minutes at 95° C., then cooled to 20° C. and measured at this temperature)].

Firstly, a masterbatch of e.g. PA66 (Radipol A45)/PA6 (Grilon A26)/Ukanol FR80 was produced as raw material mixtures, the masterbatch production being effected with a twin-screw extruder, e.g. 43/32/25 (ratio of the components PA66/PA6/FR80) for 8% end concentration of FR80. A second variant provided that the raw material mixture was supplied directly to the spin extruder.

The extrusion and the spinning were effected such that melting of the raw material mixture was effected with a spin extruder by distribution to the spinning pump or spinning pumps via melt distributor lines with multi-positional spinning arms. The melt temperature was 260-300° C.

Metering of the quantity of melt was effected by supplying it into the spinning pack with subsequent distribution of the polymer melt in the spinning pack to the individual nozzle holes and extrusion at 260-300° C. through fine capillaries into the spinning shaft below the spinning nozzle. The nozzle hole geometry is thereby determined according to the spinning titre (0.25-0.8 mm, L/D=2).

Cooling of the polymer melt was effected by the filaments, in the spinning shaft, being accelerated from the extrusion speed (5-15 m/min) to the drawing-off speed (400-1,500 m/min) and by being cooled by the blown-in air (5-20 kg air/kg PA, 20-30° C.).

Before contact with the drawing-off galettes, the filaments are prepared with 0.1 to 0.4% by weight of a commercially available spinning softener. The softener is optimised to the stretching process and the further processing of the fibres. In addition, antistatic agents and lubricants (e.g. phosphoric acid ester with ethoxylated alcohols, neutralised phosphoric acid esters and fatty acid polyglycol esters) are used. The softener should be regarded merely as a processing aid and not as an additive in the sense of the invention.

The stretching was effected subsequently according to two processes. Whilst in the one-step process stretching took place directly from drawing-off galettes onto the stretching galettes with a stretching factor 2-4, collection from the drawing-off unit was effected, in the two-step process, in cans. A large number of cans was placed in a stretching line and the filament bundle was stretched 2-5 times at 100-300 m/min.

Fixing of the fibres was effected by the filaments being heat-treated during and after the stretching process under tension (T: 80-200° C.) and after the stretching process without tension (130° C.-180° C.).

The filaments were textured and wound up. In order to produce staple fibres, the filaments were crimped or textured and subsequently cut also (30-140 mm). The cut length was determined according to the requirements of further processing in the secondary spinning machine.

The experimental data which verify the positive properties of the described blends are compiled in Tables 1 and 2. The abrasion resistance (DST=wire abrasion passages) of the fibres of Table 1 and 2 were determined according to various test methods as a function of the titre of the fibre.

In Table 1, firstly fibres with a titre of approx. 11 dtex are characterised, the flame retardant Ukanol FR80 according to the invention being used here.

Before determining the textile-mechanical properties, the polymer fibres were firstly conditioned for 3 hours at 21° C. and 60% relative air humidity.

Before determining the relative viscosity, the polymer fibres were de-softened and conditioned for 2 h at 90° C. in the vacuum drying cabinet.

The following measuring methods were used:

Wire abrasion test: the fibre is loaded with a prestress weight (0.5 g/dtex) and placed over a tungsten wire of 100 μm diameter with 90° looping. The fibres (26 fibres per measurement) are abraded with a stroke length of 5 mm and a frequency of 120 cycles/min over the tungsten wire (combination of bending and abrasion loading). The number of cycles until breakage of the fibre is measured. After deleting the highest and lowest value, the average value is formed.

Relative viscosity: according to DIN 51562-1, 0.5 g of the polymer fibre is dissolved in 100 ml m-cresol and agitated for 90 minutes at 95° C., then cooled to 20° C. and measured at this temperature.

Titre: the titre is determined according to ISO 1973 on a Vibroscope 400/Vibrodyn 400 of the Lenzing company. The process takes place according to the vibroscope method. The measurements are implemented on 25 individual fibres from a homogeneous mixed sample. The average fineness is indicated to 2 significant places.

Tenacity/elongation: the tenacity and the elongation are determined on a Vibroscope 400/Vibrodyn 400 of the Lenzing company according to ISO 5079. The clamped length is 25 mm and the measurements are implemented on 25 fibres from a homogeneous mixed sample. The prestress weight and the speed are chosen as a function of the titre (fibre with approx. 3 d/tex: prestress weight 200 mg, speed 25 mm/min; fibre with approx. 11 dtex: prestress weight of 600 mg, speed 25 mm/min).

Flame test: the flame test was implemented according to FAR 25.853, appendix F, part 1, for 12 seconds, obtainable from the Federal Aviation Association. Examples and comparative examples which complied with the test were characterised in the tables with (+) and examples or comparative examples which did not comply with the test with (−). Nonwovens with 500 to 600 g/m² were tested.

TABLE 1

| | Composition | | | | | | | |
|---|---|---|---|---|---|---|---|---|
| | Comp. | Comp. | Comp. | Comp. | | | | Comp. |
| | ex. 1 | ex. 2 | ex. 3 | ex. 4 | Ex. 1 | Ex. 2 | Ex. 3 | ex. 5 |
| PA6 [% by weight] | 100 | 0 | 90 | 0 | 24 | 10 | 24 | 4 |
| PA6 Type | A 26 | — | A 26 | — | A 26 | A 26 | A 26 | — |
| PA66 [% by weight] | 0 | 100 | 0 | 92 | 68 | 82 | 68 | 88 |
| PA66 Type | — | A 45 | — | A 45 | A45 | A45 | A3401 | — |
| FR80 [% by weight] | 0 | 0 | 10 | 8 | 8 | 8 | 8 | 8 |
| Properties | | | | | | | | |
| P-content | 0 | 0 | 0.75 | 0.6 | 0.6 | 0.6 | 0.6 | 0.6 |
| [% by weight] | | | | | | | | |
| FAR 25.853^{a)} | − | − | − | + | + | + | + | + |
| Titre [dtex] | 10.6 | 11.1 | 10.9 | 11.7 | 11.4 | 12.0 | 11.4 | 12.0 |
| Tenacity [cN/dtex] | 5.2 | 4.9 | 4.5 | 2.9 | 4.8 | 4.2 | 5.2 | 2.9 |
| Elongation [%] | 89 | 69 | 89 | 69 | 95 | 70 | 62 | 63 |
| RV in m-cresol | 1.75 | 1.81 | 1.69 | 1.66 | 1.72 | 1.70 | 1.90 | 1.70 |
| DST absolute | 14,900 | 12,600 | 9,800 | 3,900 | 12,800 | 18,200 | 49,500 | 10,500 |
| DST rel. [%] | 118 | 100 | 78 | 31 | 102 | 144 | 393 | 83 |
| Quality number | 49 | 41 | 42 | 24 | 47 | 35 | 41 | 23 |
| [cn/dtex]^{b)} | | | | | | | | |
| Textile-mechanical | 204 | 167 | 170 | 86 | 192 | 149 | 192 | 92 |
| properties [cN/dtex]^{c)} | | | | | | | | |

^{a)}Nonwovens with 500 to 600 g/m² were tested;
^{b)}Product of tenacity [cN/dtex] and square root of the elongation [%];
^{c)}Product of tenacity [cN/dtex], square root of the elongation [%] and log DST absolute.

The comparative examples were selected such that a pure PA6 system (Comp. ex. 1), a pure PA66 system (Comp. ex. 2), a flame-retardant PA6 system (Comp. ex. 3), a flame-retardant PA66 system (Comp. ex. 4) and a blend with a low PA6 proportion (Comp. ex. 5) were tested. At the same time, examples Ex. 1 to Ex. 3 according to the invention were tested, which comprised both PA6, PA66 and the flame retardant Ukanol FR80.

Correspondingly, only the examples Ex. 1 to Ex. 3 according to the invention and the comparative examples (Comp. ex. 4 and Comp. ex. 5) had flame-retardant properties which fulfil the flame test requirement according to FAR 25.853. Comparison of Ex. 1 with Ex. 3 makes it clear that the viscosity has no influence on the textile-mechanical properties and the flame-retardant properties.

It was shown that PA6 (Comp. ex. 1) has significantly better textile-mechanical properties than PA66 (Comp. ex. 2). The addition of the flame-retardant Ukanol FR80 leads to a further drastic impairment in the textile-mechanical properties. This becomes clear in particular from the comparison of pure PA66 (Comp. ex. 2) with the flame-retardant PA66 (Comp. ex. 4). In comparison with the flame-retardant system without PA6 (Comp. ex. 4), the examples Ex. 1 to Ex. 3 according to the invention show significantly improved textile-mechanical properties.

TABLE 2

| | Comp. | Comp. | Ex. | Ex. |
|---|---|---|---|---|
| Composition | ex. 6 | ex. 7 | 4^{a)} | 5 |
| PA6 [% by weight] | 0 | 0 | 10 | 10 |
| PA6 Type | — | — | A 26 | A 26 |
| PA66 [% by weight] | 100 | 96 | 82 | 82 |
| PA66 Type | A 45 | A 45 | A 45 | A 45 |
| FR80 [% by weight] | 0 | 4 | 8 | 8 |
| Properties | | | | |
| P-content [% by weight] | 0 | 0.3 | 0.6 | 0.6 |
| FAR 25.853^{b)} | — | — | + | + |
| Titre [dtex] | 2.9 | 2.8 | 2.8 | 2.9 |
| Tenacity [cN/dtex] | 4.7 | 5.5 | 4.4 | 4.5 |
| Elongation [%] | 90 | 56 | 105 | 105 |
| RV in m-cresol | 1.77 | 1.70 | 1.81 | 1.81 |
| DST absolute | 24,000 | 6,900 | 27,300 | 27,900 |
| DST rel. [%] | 100 | 29 | 114 | 116 |
| Quality number | 45 | 41 | 45 | 46 |
| [cN/dtex]^{c)} | | | | |
| Textile-mechanical properties | 195 | 158 | 200 | 204 |
| [cN/dtex]^{d)} | | | | |

^{a)}FR80 introduced via direct metering;
^{b)}Nonwovens with 500 to 600 g/m² were tested;
^{c)}Product of tenacity [cN/dtex] and square root of the elongation [%[;
^{d)}Product of tenacity [cN/dtex], square root of the elongation [%] and log DST absolute.

In Table 2, a PA66 system (Comp. ex. 6) and flame-retardant PA66 system (Comp. ex. 7) were compared with the compositions of Ex. 4 and Ex. 5 according to the invention.

It is shown also for the fibres with a smaller titre used here, with respect to the textile-mechanical properties, that the addition of PA6 according to the invention to the flame-retardant polymer system leads to a drastic improvement in the textile-mechanical properties.

In Table 3, fibres with a titre of approx. 11 dtex are characterised, organoclay being used here as flame retardant and/or a further flame retardant (IQAP-FR).

TABLE 3

| | Comp. | Comp. | Comp. |
|---|---|---|---|
| Composition | ex. 8 | ex. 9 | ex. 10 |
| PA6 [% by weight] | 10 | 10 | 10 |
| PA6 Type | A 26 | A 26 | A 26 |
| PA66 [% by weight] | 85.0 | 83.2 | 80.2 |
| PA66 Type | A 45 | A 45 | A 45 |
| MB IQAP-FR | 5.0 | 5.0 | 0 |
| Organoclay^{a)} | 0 | 1.8 | 1.8 |
| FR80 [% by weight] | 0 | 0 | 8 |
| Properties | | | |
| FAR 25.853^{b)} | — | — | — |
| Titre [dtex] | 11.4 | 10.4 | 11.7 |
| Tenacity [cN/dtex] | 4.2 | 3.7 | 3.3 |
| Elongation [%] | 111 | 114 | 61 |
| RV in m-cresol | 1.7 | 1.7 | 1.8 |
| DST absolute | 17,500 | 7,800 | 6,400 |
| DST rel. [%] | 144^{e} | 62^{e} | 51^{e} |
| Quality number^{c)} | 44 | 40 | 26 |
| Textile-mechanical properties | 187 | 153 | 98 |
| [cN/dtex]^{d)} | | | |

^{a)}Organoclay: Cloisite 20A;
^{b)}Nonwovens with 500 to 600 g/m² were tested;
^{c)}Product of tenacity [cN/dtex] and square root of the elongation [%];
^{d)}Product of tenacity [cN/dtex], square root of the elongation [%] and log DST absolute;
^{e)}Relative to Comp. ex. 2.

Furthermore, flame-retardant polymer systems have been tested in which a different flame retardant was used (Table 3). Organoclay and a flame-retardant with the designation IQAP-FR and also organoclay and Ukanol FR80 according to the invention were used here as flame retardant.

It can be deduced from the table that mixing an organoclay as flame retardant impairs the textile-mechanical properties, this emerges from the comparison of Comp. ex. 8 with Comp. ex. 9. In addition, neither the combination of IQAP and organoclay nor the combination of Ukanol FR80 and organoclay (Comp. ex. 10) pass the fire test according to FAR 25.853. When using only 1.8% of the organoclay and 8% of the flame retardant according to the invention (Comp. ex. 10), the textile-mechanical properties drop to <100 cN/dtex. Mixing an organoclay which is known from the state of the art for inorganic flame retardants leads to negative properties in the case of the flame retardant according to the invention. It can be concluded from these comparative tests that only with the flame retardant Ukanol FR 80 used according to the invention by mixing in PA6 to PA66 is the flame test according to FAR 25.583 passed and also better textile-mechanical properties than for PA66 are obtained. If however IQAP-FR or the combination IQAP-FR or FR 80 with organoclay are used as flame retardant, poorer values result here than for the PA66 fibre without additives.

Furthermore, the fibres according to the invention, as shown in Table 4, have very good resistance to washing-out. 5 g of the polymer fibre according to the composition of example 2 was extracted in 150 ml deionised water. The fibre was firstly added for this purpose into a 23° C., temperature-controllable (Labomat) water bath and heated at a heating rate of 1.5° C. per minute to 98° C. At this temperature, the extraction was continued for 3 hours. After the extraction, the polymer fibre was centrifuged and dried at 23° C. The phosphorus content was determined before and after the extraction by means of ICP=ion coupled plasma (decomposition of the sample with nitric acid and measurement on a Varian 720-ES). The phosphorus content determined after extraction was only 1% lower than the phosphorus content before extraction.

TABLE 4

| | P-content [ppm] |
|---|---|
| Before extraction | 5,953 |
| After extraction | 5,891 |
| Difference | 62 |

1. Flame-retardant polymer fibre made of a polymer blend of polyamide 6 and polyamide 66 having a composition comprising:
I) 60 to 90% by weight of polyamide 66 (PA66),
II) 6 to 28% by weight of polyamide 6 (PA6),
III) 4 to 12% by weight of at least one halogen-free flame retardant made of a polycondensate of
at least one phosphorus-containing monomer which is selected from adducts of
a) at least one phosphorus-containing monomer which is selected from adducts of
a1) 9,10-dihydro-9-oxa-10-phosphaphenanthrene-10-oxide (DOPO) and/or nuclear-substituted DOPO derivatives in
a2) unsaturated compounds selected from the group of mono- and multivalent carboxylic acids and anhydrides thereof and
b) at least one ester-forming monomer selected from the group of mono- or multivalent alcohols and mixtures thereof.

2. The flame-retardant polymer fibre according to claim 1, wherein the composition of the polymer fibre comprises at least one additive.

3. The flame-retardant polymer fibre according to claim 2, having the following composition:
I) 75 to 85.99% by weight, of polyamide 66,
II) 7 to 11% by weight of polyamide 6,
III) 7 to 10% by weight of at least one halogen-free flame retardant of the polycondensate, and
IV) 0.01 to 4% by weight of the at least one additive.

4. The flame-retardant polymer fibre according to claim 2, wherein the composition of the polymer fibre, relative to the total quantity of PA66 I), PA6 II) and flame retardant III), comprises 0.001 to 5% by weight of the at least one additive.

5. The flame-retardant polymer fibre according to claim 1, wherein the product of the tenacity in cN/dtex, the square root of the elongation in % and the common logarithm of the number of cycles until fibre breakage in the wire abrasion test is greater than 100 cN/dtex.

6. The flame-retardant polymer fibre according to claim 1, wherein the polymer fibre displays an abrasion resistance in the wire abrasion test of 10,000 to 50,000 cycles until fibre breakage.

7. The flame-retardant polymer fibre according to claim 1, wherein the polymer fibre has a quality number of 28 to 50.

8. The flame-retardant polymer fibre according to claim 1, wherein the polymer fibre has a tenacity in [cN/dtex] of 3.5 to 6.0.

9. The flame-retardant polymer fibre according to claim 1, wherein the polymer fibre has an elongation of 20 to 120.

10. The flame-retardant polymer fibre according to claim 1, wherein the fibre fulfills the flame test requirements according to FAR 25.853.

11. The flame-retardant polymer fibre according to claim 1, wherein the polymer fibre shows increased extraction resistance, measured by means of extraction from 5 g of the polymer fibre in 150 ml deionised water, the fibre being added to a 23° C. temperature-adjustable water bath, heated to 98° C. at a heating rate of 1.5° C. per minute and extracted at this temperature for 3 hours and the phosphorus content before and after the extraction differing by less than 2.5%.

12. The flame-retardant polymer fibre according to claim 1, wherein the at least one additive is contained in a quantity such that the polymer fibre has at least one of the following properties:
the polymer fibre fulfills the flame test requirement according to FAR 25.853
the polymer fibre has a quality number in the range of 28 to 50.

13. The flame-retardant polymer fibre according to claim 1, wherein the at least one additive
is a further flame retardant selected from nitrogen-containing compounds, nitrogen- and phosphorus-containing compounds and mixtures hereof, and/or
is selected from inorganic stabilisers, organic stabilisers, colourants and marking materials, inorganic pigments, organic pigments, IR absorbers, heat stabilisers, antistatic agents, antiblocking agents, nucleation agents, crystallisation accelerators, crystallisation inhibitors, matting agents, in particular titanium dioxide as matting agent, chain-lengthening additives, conductivity additives, carbon black, graphite, carbon nanotubes, optical brighteners, photochromic additives, crosslinking agents, intumescence agents, foreign polymers and/or mixtures thereof.

14. A textile fabric comprising the flame-retardant polymer fibre according to claim 1.

15. Textile fabric according to claim 14,
wherein the fabric is a carpet, seat cover for a mobile means of transport, a seat cover or a blind in public buildings, a clothing- or protective material in textile floor coverings, seat upholstery, or furniture cover materials.

16. (canceled)

17. A method of producing flame-retardant textile fabrics comprising utilizing the flame-retardant polymer fiber according to claim 1 in the production of said textile fibres.

18. The flame-retardant polymer fibre according to claim 2, having the following composition:
I) 80 to 84.9% by weight of polyamide 66,
II) 7.5 to 9% by weight of polyamide 6,
III) 7.5 to 9% by weight of at least one halogen-free flame retardant of the polycondensate, and
IV) 0.1 to 2% by weight of the at least one additive.

19. The flame-retardant polymer fibre according to claim 3, wherein the composition of the polymer fibre, relative to the total quantity of PA66 I), PA6 II) and flame retardant III), comprises 0.001 to 5% by weight of at least one additive.

20. The flame-retardant polymer fibre according to claim 18, wherein the composition of the polymer fibre, relative to the total quantity of PA66 I), PA6 II) and flame retardant III), comprises 0.001 to 5% by weight of at least one additive.
